(19) United States
(12) Patent Application Publication
(10) Pub. No.: US 2026/0105099 A1
(43) Pub. Date: Apr. 16, 2026

(54) Image-Based Object Identification Scalability Improvement

(71) Applicant: MICRO FOCUS LLC, Wilmington, DE (US)

(72) Inventors: Bin Li, Shanghai (CN); Alex Zhou, Shanghai (CN); Ryan Li, Shanghai (CN)

(73) Assignee: MICRO FOCUS LLC, Wilmington, DE (US)

(21) Appl. No.: 18/917,745

(22) Filed: Oct. 16, 2024

(51) Int. Cl. G06F 16/532; G06T 1/60; G06T 5/40; G06V 10/74

(52) U.S. Cl. CPC G06F 16/532; G06T 1/60; G06T 5/40; G06V 10/761

(57) ABSTRACT

Systems and methods are disclosed for image-based object identification and include receiving a search request including a captured image of a graphical user interface from an application under test, comparing the captured image with at least one stored image in a cache, calculating a comparison value between the captured image and the at least one stored image in a cache, determining if the captured image has been stored in a cache by comparing the captured image with at least one stored image in the cache and calculating a comparison value between the captured image and the at least one stored image. If the comparison value exceeds a threshold value, returning the at least one stored image to the application under test and if the comparison value does not exceed the threshold value, forwarding the search request including the captured image to a remote detection service for image detection.

### FIELD OF THE DISCLOSURE

The invention relates generally to systems and methods for analyzing applications under test to detect objects and particularly relates to systems and methods for analyzing applications under test to detect objects using image-based object identification.

### BACKGROUND

Computer programs (e.g., applications) executed by at least one processor require testing to ensure that the instructions of the application work as intended and/or do not contain code that could be harmful to privacy or cause undesired, and otherwise unknown, operations. Image-based object identification is a good technique to detect objects in applications under test in the application user interface since this technique is effective and flexible. In functional testing, image-based object identification is widely used in different kinds of applications since this technique can ignore the technical details of the application's implementation. In performance testing, however, image-based object identification experiences more challenges. During performance testing, there may be thousands of virtual users running. With thousands of virtual users running at the same time, a detection service would become overburdened with many calls at one time. Since object detection is a resource-intense task and the technique employed is based on artificial intelligence (AI) technology, it may be even more complex, and many calls to the detection service may cause a bottleneck in the testing process. Therefore, what is needed is a simplified way of detecting objects in applications under test in both functional testing and performance testing.

### SUMMARY

Improving the efficiency of a detection method still requires the most time-consuming node among the entire testing process. According to embodiments of the present disclosure, the improved efficiency of the detection method reduces the number of calls to the detection service.

Performance testing has a notable feature. For example, for a same step of a test script, an application user interface (UI) between different iterations of the test script and between different application UIs of virtual users should look the same or similar. As defined herein, a test script is a set of instructions or steps that are executed to verify that a system or component behaves as expected. For example, a test script could represent a business flow that ensures that every step of the business operation is managed effectively. As another more specific example, the test script could include the following steps: (1) navigate to a login page; (2) enter a valid username in a username field; (3) enter a valid password in a password field; (4) enter a verification code; and (5) click the “Login” button. The business flow is usually tested several times, or the business flow repeatedly runs for a specified period. Therefore, the test script will run several times. Each time the test script runs is called an iteration of the test script. A specific step (e.g., enter a valid password in a password field), in a different iteration is called a same step of the test script.

Based on this, embodiments of the present disclosure implement a cache layer before a detection service. An application, using an application testing tool for example, first sends a search query or search condition to the cache layer. The search condition may include, for example, a screenshot of an application UI, target object descriptions (e.g., properties, template image, etc.) and other information deemed necessary for searching for the target object. If the search condition is not found in the cache layer, the search condition is forwarded to the detection service. The search results from the detection service for the search condition are sent to the application and also saved in the cache layer. If the search condition is found in the cache layer, the cache layer returns the cached search results without the search condition being sent to the detection service.

These and other needs are addressed by the various embodiments and configurations of the present invention. The present invention can provide a number of advantages depending on the particular configuration. These and other advantages will be apparent from the disclosure of the invention(s) contained herein.

In some aspects, the techniques described herein relate to a method, including receiving, by a processor, a search request including a captured image of a graphical user interface from an application under test, comparing, by the processor, the captured image with at least one stored image in a cache, calculating, by the processor, a comparison value between the captured image and the at least one stored image in a cache and determining, by the processor, if the captured image has been stored in a cache by comparing, by the processor, the captured image with at least one stored image in the cache and calculating, by the processor, a comparison value between the captured image and the at least one stored image. If the comparison value exceeds a threshold value, returning, by the processor, the at least one stored image to the application under test. Moreover, if the comparison value does not exceed the threshold value, forwarding, by the processor, the search request including the captured image to a remote detection service for image detection.

In some aspects, the techniques described herein relate to a method, further including receiving, by the processor, search results from the remote detection service based on the forwarded search request, wherein search results include at least one candidate image, updating, by the processor, the cache with the search request and the at least one candidate image and sending, by the processor, the at least one candidate image to the application under test.

In some aspects, the techniques described herein relate to a method, further including if the at least one candidate image includes one candidate image having a confidence score exceeding a predetermined value, updating, by the processor, the cache with the search request and a unique object extracted from the one candidate image instead of the one candidate image.

In some aspects, the techniques described herein relate to a method, further including if the at least one candidate image includes one candidate image having a confidence score exceeding a predetermined value, sending, by the processor, a unique object extracted from the one candidate image instead of the one candidate image to the application under test.

In some aspects, the techniques described herein relate to a method, further including determining, by the processor, if the unique object extracted from the one candidate image matches at least one stored object in the cache.

In some aspects, the techniques described herein relate to a method, wherein the comparison includes a structural comparison and a pixel comparison.

In some aspects, the techniques described herein relate to a method, wherein the structural comparison includes a structural similarity index method.

In some aspects, the techniques described herein relate to a method, wherein the pixel comparison includes comparing distances between histograms of images.

In some aspects, the techniques described herein relate to a method, wherein probabilities from the structural comparison and the pixel comparison are combined to determine the threshold value.

In some aspects, the techniques described herein relate to a system, including a processor and a memory coupled with and readable by the processor and storing therein a set of instructions which, when executed by the processor, causes the processor to receive a search request including a captured image of a graphical user interface from an application under test, and determine if the captured image has been stored in a cache by compare the captured image with at least one stored image in the cache and calculate a comparison value between the captured image and the at least one stored image. If the comparison value exceeds a threshold value, return the at least one stored image to the application. Moreover, if the comparison value does not exceed the threshold value, forward the search request including the captured image to a remote detection service for image detection.

In some aspects, the techniques described herein relate to a system, wherein the instructions further cause the processor to receive search results from the remote detection service based on the forwarded search request, wherein the search results include at least one candidate image, update the cache with the search request and the at least one candidate image and send the at least one candidate image to the application under test.

In some aspects, the techniques described herein relate to a system, wherein the instructions further cause the processor to if the at least one candidate image includes one candidate image having a confidence score exceeding a predetermined value, update the cache with the search request and a unique object extracted from the one candidate image instead of the one candidate image.

In some aspects, the techniques described herein relate to a system, wherein the instructions further cause the processor to if the at least one candidate image includes one candidate image having a confidence score exceeding a predetermined value, send a unique object extracted from the one candidate image instead of the one candidate image to the application under test.

In some aspects, the techniques described herein relate to a system, wherein the instructions further cause the processor to determine if the unique object extracted from the one candidate image, matches at least one stored object in the cache.

In some aspects, the techniques described herein relate to a system, wherein the comparison includes a structural comparison and a pixel comparison.

In some aspects, the techniques described herein relate to a system, wherein the structural comparison includes a structural similarity index method.

In some aspects, the techniques described herein relate to a system, wherein the pixel comparison includes comparing distances between histograms of images.

In some aspects, the techniques described herein relate to a system, wherein probabilities from the structural comparison and the pixel comparison are combined to determine the threshold value.

In some aspects, the techniques described herein relate to a non-transitory computer readable medium having stored thereon instructions that cause a processor to execute a method, the method includes instructions to receive a search request including a captured image of a graphical user interface from an application under test and determine if the captured image has been stored in a cache by comparing the captured image with at least one stored image in the cache and calculating a comparison value between the captured image and the at least one stored image. If the comparison value exceeds a threshold value, return the at least one stored image to the application under test. Moreover, if the comparison value does not exceed the threshold value, forward the search request including the captured image to a remote detection service for image detection.

In some aspect, the techniques described herein relate to a non-transitory computer readable medium, wherein the instructions further cause the processor to: receive search results from the remote detection service based on the forwarded search request, wherein the search results include at least one candidate image; update the cache with the search request and the at least one candidate image; and send the at least one candidate image to the application under test.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

### BRIEF DESCRIPTION OF THE DRAWINGS

The present disclosure is described in conjunction with the appended figures:

FIG. 1 is a block diagram of an illustrative system for analyzing applications under test (AUT) to detect objects using image-based object identification in accordance with embodiments of the present disclosure;

FIG. 2 is a block diagram of a computing device in accordance with embodiments of the present disclosure;

FIG. 3 illustrates example graphical user interface (GUI)s in accordance with embodiments of the present disclosure;

FIG. 4 illustrates another example GUI in accordance with embodiments of the present disclosure; and

FIG. 5 depicts a flow diagram depicting a method for analyzing AUT to detect objects using image-based object identification in accordance with embodiments of the present disclosure.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The detailed description provides embodiments only and is not intended to limit the scope, applicability, or configuration of the claims. Rather, the detailed description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112 (f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

Software applications are often tested by running a test script to verify that the applications and the source code therein behave as expected and intended. An “application,” as used herein, may refer to any software application comprising code or machine-readable instructions for implementing various functions. A “test,” as used herein, may refer to a single test or a test suite comprising a set of related tests. When a particular test is executed, a test script corresponding to the particular test may be executed and/or run. When executed, the particular test may test various aspects of the application to verify that the application and the code therein behave as expected and intended. In many cases, an application may undergo a large number of tests covering different aspects or features of the application. Software development and software testing are each a technical activity which cannot be performed mentally, or entirely by pen and paper.

As described herein, a cache layer is provided between an application under test (AUT) and a detection service. A search condition (e.g. a search request, a search query, etc.) is first sent to the cache layer. If the search results based on the search condition have already been cached by the cache layer, the cached search results based on the search condition are directly returned to the AUT. If the search results based on the search condition have not already been cached by the cache layer, the search condition is forwarded to the detection service from the cache layer for processing. The search results based on the search condition are sent to the AUT and the cache layer is updated with the search results for the search condition.

In general, a typical application user interface (UI) may have dynamic content and/or animations, so every time a screenshot of the application UI is captured (e.g., each time a webpage is refreshed), the application UI may not be exactly the same between different iterations or between different virtual users. Therefore, the differences between iterations or between different virtual users will not impact target object finding. Therefore, the cache tolerates these differences in iterations. After the first search condition from the application to the detection service has been executed, subsequent search conditions utilize the cache for similar detection request. As described herein, similar search conditions include a captured screenshot of an application UI having similar objects displayed therein and a similar requested target object.

As indicated in the examples above and will be evident in the present disclosure, various aspects of the present disclosure provide a unique computing solution to a unique computing problem that did not exist prior to retrieval of cached search results. Implementations of the subject matter disclosed herein provide meaningful improvements to processing and storage of images by a computer system by allowing for cached images to be retrieved instead of unnecessarily utilizing the resources of the detection service, thus improving computer functionality and operation. As such, implementations of the subject matter disclosed herein are not an abstract idea such as organizing human activity or a mental process that can be performed in the human mind, much less using pen and paper.

By efficiently using cached images instead of relying on the resources of the detection service results in a much more efficient computing system using the same hardware. The described embodiments of the present disclosure make the existing hardware more efficient while reducing the overall cost of image retrieval during application testing which was previously impossible. Being able to retrieve images in real-time is clearly something that cannot be done practically using a mental process. Instead, image retrieval based on cached images in real-time described herein will only work practically in a computerized environment.

Being able to support a higher number of image searches based on cached images more efficiently and at a lower cost cannot be performed manually and in real-time. For example, being able to support a higher number of image searches cached image more efficiently and at a lower cost involves managing terra bytes of information from a very large number of devices to identify issues from a very large number of users in real-time (e.g., thousands of users). Being able to support a higher number of image searches based on cached images more efficiently and at a lower cost would simply take too long if performed using a pen and paper.

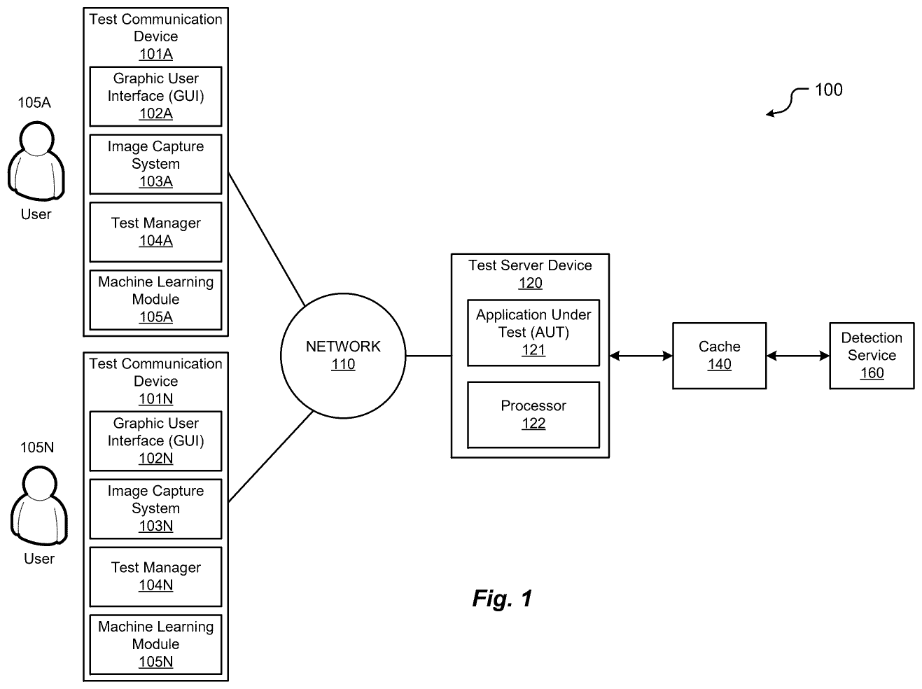

FIG. 1 is a block diagram of an illustrative system 100 for analyzing AUTs to detect objects using image-based object identification in accordance with embodiments of the present disclosure. The system 100 may be accessed by one or more users 105A-105N using the corresponding one or more test communication devices 101A-101N. The illustrative system 100 may include the users 105A-105N, the test communication devices 101A-101N, a network 110, a test server device 120, a cache 140 and a detection service 160.

Test communication devices 101A-101N can be or may include any user communication endpoint device that can communicate on the network 110, such as a Personal Computer (PC), a tablet device, a notebook device, a smart phone, and/or the like. Test communication devices 101A-101N may be used to access the test server device 120. As shown in FIG. 1, any number of test communication devices 101A-101N may be connected to the network 110.

The test communication devices 101A-101N each includes a graphical user interface (GUI) 102A-102N, an image capture system 103A-103N, a test manager 104A-104N, and a machine learning module 105A-105N. As defined herein a GUI is a type of user interface that allows users to interact with software applications through graphical elements such as windows, icons, buttons, and menus. GUIs are designed to be intuitive and visually oriented, enabling users to perform tasks with minimal text input. As defined herein, the term “Application User Interface” refers more broadly to the interface that an application provides for its users to interact with its functionality. It includes not just graphical elements (as in a GUI) but also any other forms of interaction, such as command-line interfaces (CLI), voice user interfaces (VUI), or even Application Programming Interface (API)s that enable other software to interact with the application. The GUI 102A-102N displays graphical information provided by the application or application under test (AUT) 121. For example, the GUI 102A-102N may display graphical information of a browser.

The image capture system 103A-103N is used to capture an image of the GUI 102A-102N. The image capture system 103A-103N may include a camera that captures the GUI 102A-102N. Alternatively, the image capture system 103A-103N may analyze graphical data being sent for display on the test communication device 101A-101N in the GUI 102A-102N. The image capture system 103A-103N uses a display screen of the GUI 102A-102N to detect changes in the GUI 102A-102N. For example, the image capture system 103A-103N may analyze different frames of the display screen to identify changes in the GUI 102A-102N.

The test manager 104A-104N is used to identify actionable graphical objects in the GUI 102A-102N based on the detected changes to the GUI 102A-102N. An actionable graphical object is a graphical object where a mouse click on the actionable graphical object causes an event. For example, an actionable graphical object may be a button, a scroll bar, a check box, an icon, a link, a tab, a menu, a menu item, a text field, a text area, a slider, a control, and/or the like. The test manager 104A-104N uses the results of detection of actionable graphical objects to run tests against the AUT 121.

The machine learning module 105A-105N may use a variety of machine learning algorithms, such as, supervised machine learning, unsupervised machine learning, reinforcement machine learning, semi-supervised machine learning, self-supervised machine learning, multi-instance machine learning, inductive machine learning, deductive machine learning, transductive machine learning, and/or the like. The machine learning module 105A-105N may be used to learn, over time, which graphical objects that are actionable graphical objects.

Although not illustrated, the test communication devices 101A-101N may further include a processor, a test program and a code execution module. The processor can be or may include any kind of processor that can process computer code, such as, a hardware processor, a microprocessor, a micro controller, a multi-core processor, an application specific processor, a virtual machine, and/or the like.

The test program can be or may include any software/hardware that can generate test(s) for testing the AUT 121. The test program can be written in various programming languages, such as, C, C++, JAVA®, JAVAScript, Hyper Text Markup Language (HTML), PERL, and/or the like. The test program may include any of the test scripts/APIs/text syntax described herein in conjunction with any known programming languages.

The code execution module can be or may include any hardware/software that can be used to execute the test program. The code execution module may run any developed test scripts/test programs using the text syntax/APIs described herein. The code execution module may be a code interpreter, may execute code that has been compiled into binary code, and/or the like.

The network 110 can be or may include any collection of communication equipment that can send and receive electronic communications, such as the Internet, a Wide Area Network (WAN), a Local Area Network (LAN), a Voice over IP Network (VOIP), a combination of these, and the like. The network 110 can use a variety of electronic protocols, such as Ethernet, Internet Protocol (IP), Session Initiation Protocol (SIP), Integrated Services Digital Network (ISDN), and the like. Thus, the network 110 is an electronic communication network configured to carry messages via packets and/or circuit switched communications.

The cache 140 can be or may include any hardware system that can facilitate communications on the network 110 and stores data from the detection service 160.

The test server device 120 can be or may include any hardware system that can host AUT 121, such as a web server, a media server, and/or the like. The test server device 120 may also include a processor 122.

Applications can be any application to be used as an AUT 121 to create a tutorial video, such as a recording application, a calendar application, a video application, a web browser application, an Instant Messaging application, an email application, a call screening application, a conferencing application, and/or the like. As described herein, application may also refer to a website or mobile application. Applications may communicate via an API. For example, the API may be an Extended Markup Language (XML) interface, a JAVA Speech API (JSAPI) application, and/or the like.

The detection service 160 can be or may include any hardware system that can facilitate communications on the network 110 and provide image detection services. According to embodiments of the present disclosure, detection services 160 may provide services that include content moderation and safety features. These services analyze images to detect inappropriate content, violence, nudity, or other content that may violate policies. For example, Google® Cloud Vision API offers features like image content analysis, safe search detection, and object detection. Amazon® ReKognition: provides the capabilities to detect unsafe content, text in images, faces, and more. Microsoft Azure Content Moderator offers image moderation features, including detecting adult content and offensive text. According to further embodiments of the present disclosure, detection service 160 may provide services that include image recognition and object detection features. These services identify objects, scenes, and activities within images. For example, Clarifai provides a robust tool for image recognition, providing models for detecting various objects, concepts, and scenes. IBM® Watson Visual Recognition offers pre-trained models and the ability to train custom models for specific needs. DeepAI provides various image recognition APIs, including nudity detection and content moderation.

According to embodiments of the present disclosure, detection service 160 may provide services that include reverse image searches. For example, these services allow a user to find similar images or track image usage across the web. TinEye provides a reverse image search engine that can find the origin of images, how they are being used, and where they appear. Google® Images offers a reverse image search feature to find similar images and identify image sources. According to embodiments of the present disclosure, detection service 160 may provide custom solutions that allows users to use machine learning frameworks like TensorFlow, PyTorch, or using pre-trained models available through platforms like Hugging Face in order to image detection services.

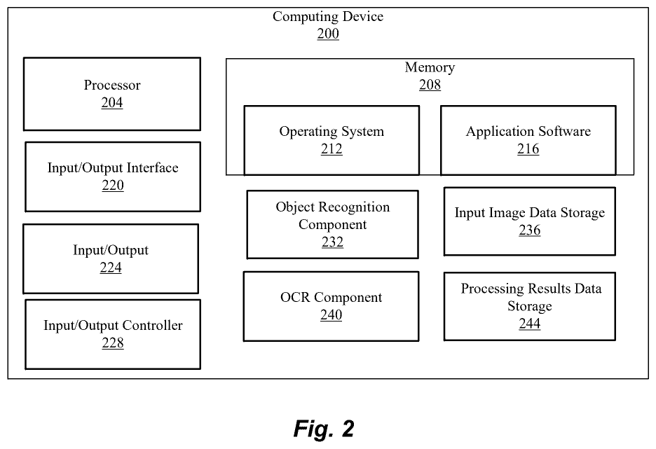

FIG. 2 is a block diagram of a computing device 200 in accordance with embodiments of the present disclosure. In FIG. 2, the computing device 200 may implement some or all of the computerized object detection using image-based object identification described herein. In some embodiments of the present disclosure, components of the computing device 200 may be implemented as a part of an electronic device according to one or more embodiments described in this specification.

The computing device 200 performs text and object recognition in accordance with the embodiments disclosed of the present disclosure. The computing device 200 receives image data for processing. For example, the computing device 200 may be configured to receive one or more input images from a user and/or may be operable to poll network locations, such as via the Internet, to capture images for processing. The computing device 200 may store any image data and/or other data in a memory 208. A similar computing device 200 may be included in test communication devices 101, test server device 120 and/or detection service 160 as illustrated in FIG. 1, in whole or in part, described herein to perform the automatic testing of a webpage layout.

The computing device 200 illustrated in FIG. 2 is representative of any computing system or systems with which the various operational architectures, processes, scenarios, and sequences disclosed herein to perform the automatic identification of text and objects.

The computing device 200 may include one or more processors 204 which may be microprocessors, controllers or any other suitable type of processors for processing computer-executable instructions to control the operation of the electronic device. Platform software including an operating system 212 or any other suitable platform software may be provided on the computing device 200 to enable application software 216 to be executed on the computing device 200.

The processor 204 can be any hardware microprocessor that can execute the operating system 212 and other applications (e.g., application software 216), such as, a microcontroller, a multi-core processor, an application specific processor, and/or the like. The processor 204 is used to execute instructions for running the operating system 212, the application software 216, etc. The input/output interface 220 may also include hardware components, such as network interface cards, graphics processors, video processors, input ports (e.g., USB ports), and/or the like.

The operating system 212 can be or may include any type of operating system that can support containerized services, such as, a distributed operating system, a network operating system, a multi-tasking operating system, a time-sharing operating system, a general purpose operating system, and embedded operating system, and/or the like. The operating system may be a Microsoft Windows™ operating system, a Linux™ operating system, an Android™ operating system, an Apple™ iOS operating system, and/or the like. The computing device 200 may be a host for a system without using containers and/or for one or more virtual machines. For example, the systems and methods as described herein may be implemented using a virtual machine.

Computer-executable instructions may be provided using any computer-readable media that are accessible by the computing device 200. Computer-readable media may include, for example, computer storage media such as a memory 208 and communications media. Computer storage media, such as a memory 208, includes volatile and non-volatile, removable and non-removable media implemented in any method or technology for storage of information such as computer-readable instructions, data structures, program modules or the like. Computer storage media include, but are not limited to, RAM, ROM, EPROM, electrically erasable programmable read-only memory (EPROM), flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Propagated signals per se are not examples of computer storage media. Although the computer storage medium (the memory 208) is shown within the computing device 208, it will be appreciated by a person skilled in the art, that the storage may be distributed or located remotely and accessed via a network or other communication link (e.g., using the input/output interface 220).

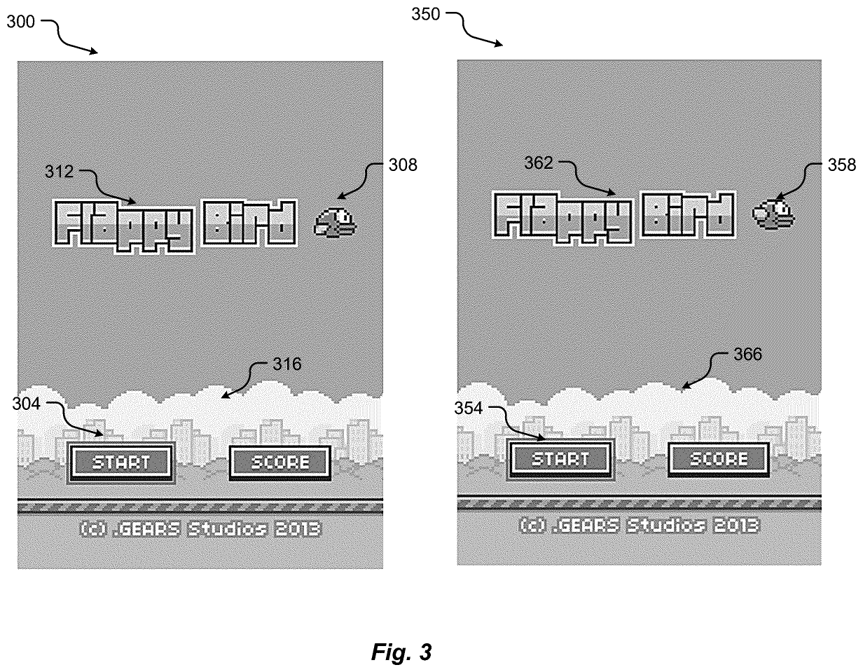

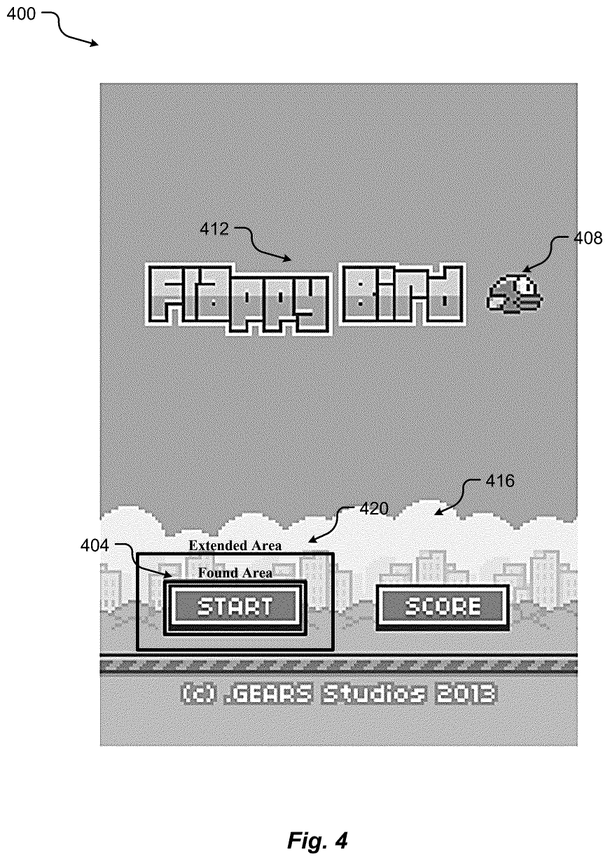

The input/output interface 220 may include multiple interfaces such as a communication interface and/or a user interface system. The input/output interface 220 may include a communication interface including components that communicate over communication links, such as network cards, ports, radio frequency (RF), processing circuitry and software, or some other communication devices. A communication interface may be configured to communicate over metallic, wireless, or optical links. A communication interface may be configured to use Time Division Multiplex (TDM), Internet Protocol (IP), Ethernet, optical networking, wireless protocols, communication signaling, or some other communication format-including combinations thereof. In some implementations of the present disclosure, a communication interface is configured to communicate with other devices external to the computing device 200. The user interface system of the computing device 200 may be configured to generate a user interface to be displayed on a display device. The user interface may be as illustrated in FIGS. 3 and 4 as described below.

The processing circuitry of the computing system 200 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.), such as received via a bus, executes instructions, and outputs data, again such as via the bus. In other embodiments, the processing circuitry may comprise a shared processing device that may be utilized by other processes and/or process owners, such as in a processing array or distributed processing system (e.g., “cloud,” farm, etc.). It should be appreciated that the processing circuitry may be a non-transitory computing device (e.g., electronic machine comprising circuitry and connections to communicate with other components and devices). The processing circuitry may operate a virtual processor, such as to process machine instructions not native to the processor (e.g., translate Intel® chipset code to emulate a different processor's chipset or a non-native operating system, such as a VAX operating system on a Mac), however, such virtual processors are applications executed by the underlying processor and the hardware and other circuitry thereof.

The processing circuitry in some embodiments comprises a microprocessor and other circuitry that retrieves and executes the operating software from the storage system. The storage system may include volatile and nonvolatile, removable, and non-removable media implemented in any method or technology for storage of information, such as computer readable instructions, data structures, program modules, or other data. The storage system may be implemented as a single storage device but may also be implemented across multiple storage devices or sub-systems. The storage system may comprise additional elements, such as a controller to read the operating software.

The computing device 200 may include an input/output controller 228 configured to output information to one or more output devices 224, for example, a display or a speaker, which may be separate from or integral to the computing device 220. The input/output controller 228 may also be configured to receive and process an input from one or more input devices 224, for example, a keyboard, a microphone or a touchpad. In one embodiment, the output device 224 may also act as the input device. An example of such a device may be a touch-sensitive display. The input/output controller 228 may also output data to devices other than the output device, e.g., a locally connected printing device. In some embodiments of the present disclosure, a user may provide input to the input device(s) 224 and/or receive output from the output device(s) 224.

The functionality described herein can be performed, at least in part, by one or more hardware logic components. According to an embodiment of the present disclosure, the computing device 200 is configured by the program code when executed by the processor 204 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

The computing device 200 may also include object recognition component 232. The object recognition component 232 may include an artificial intelligence system capable of analyzing image data and outputting data indicating whether any objects are found in the image data. For example, the object recognition component 232 may output a list of all objects found within the image data. The list of objects may include data such as the position of each object, a size of each object, a type or estimated type of each object, and/or other information. As described herein, an object may comprise a visual aspect of a user interface. Objects may be used in windows of applications, websites, dialog boxes, etc. Some objects may be configured to display information and/or enable a user to input data.

Objects may include GUI elements configured to be displayed on user devices. Example control objects include, but are not limited to, text entry boxes, text fields, push buttons, radio buttons, check boxes, drop-down list boxes, selection boxes, scroll bars, group boxes, etc.

In some embodiments of the present disclosure, the object recognition component 232 may be an artificial intelligence system which may be trained to identify objects given an input image. Identifying an object may include determining the type, size, and location of the object. For example, the object recognition component 232 may be configured to identify an object, determine the object is one of a text entry box, text field, push button, radio button, check box, drop-down list box, selection box, scroll bar, group box, etc., determine a size of the object, such as by length and width, and determine a location of the object within the input image, such as by a coordinate system, for example, an x-y coordinate system.

The computing device 200 may further include an optical character reader (OCR) component 240. The OCR component 240 may in some embodiments of the present disclosure be an application or service configured to identify text within image data. In some embodiments of the present disclosure, the OCR component 240 may be configured to identify blocks or fields of text. For example, the OCR component 240 may be configured to determine whether two characters of text are part of the same sentence or phrase. Such a determination may be made based on a detected separation of the characters. The OCR component 240 may be configured to output an indication of locations of text, size of text, and other information for a given input image. In some embodiments of the present disclosure, a trained artificial intelligence system, such as a convolutional neural network, trained to recognize text may be used. The OCR component 240 may also be configured to identify blocks or groups of text in addition to recognizing characters of text.

The computing device 200 in some embodiments of the present disclosure include an input image data storage system 236. The input image data storage system 236 may be a set of memory within the computing device 200 or may be a data location available to the computing device 200, such as stored in a network location. The input image data storage system 236 may be configured to store input images which are to be used for processing in the memory 208 so that the input images are available when needed.

The computing device 200 may in some embodiments of the present disclosure include a processing results data storage system 244. Similar to the input image data storage system 236, the processing results data storage system 244 may be a set of memory within the computing device 200 or may be a data location available to the computing device 200, such as stored in a network location. The processing results data storage system 244 may be configured to store results of processing, which may be in the form of text or other types of data, in the memory 208 so that the input images are available when needed.

FIG. 3 illustrates example GUIs 300 and 350 in accordance with embodiments of the present disclosure. As illustrated in FIG. 3, GUIs 300 and 350 provide dynamic content or animations, so even for the same step of a test script for an AUT, the GUIs may not be exactly the same between different iterations or for different virtual users. As illustrated in FIG. 3, GUIs 300 and 350 are similar and any differences will not impart finding the target object. GUIs 300 and 350 each depict a canvas game entitled “Flappy Bird” 312 and 362, illustrating the bird 308 and 358 and the ground elements 316 and 366. These features are animations that appear differently in each screenshot represented in the GUIs 300 and 350. For example, the wing of the bird 308 illustrated in GUI 300 is in a different position than the wing of the bird 358 illustrated in GUI 350. This difference in the screenshots represented in the GUIs 300 and 350, however, does not impact finding the target object (e.g., the START button 304 and 354).

According to embodiments of the present disclosure, the cache 140 tolerates differences between screenshots of similar subject matter using various algorithms as discussed in greater detail below. Ideally for a same step of a test script, the AUT 121 calls the detection service 160 for a first search condition, and for subsequent search conditions involving the same/similar subject matter, the AUT 121 first contacts the cache 140 to determine if search results for the search condition have been stored. If the search results have been stored in the cache 140, the detection service 160 is not contacted. Therefore, according to embodiments of the present disclosure, calls to the detection service 160 can be reduced and the overall performance of the system can be improved. Therefore, if a screenshot represented by GUI 300 that identifies the START button 304 as the target object is already stored in the cache 140 and the AUT 121 requires a subsequent search condition involving the same/similar subject matter (e.g., the GUI 350 identifying the same target object of the START button 354), the AUT 121 first contacts the cache 140 to determine if the screenshot represented by the GUI 300 that identifies the START button 304 as the target object already exists in the cache 140. The cache 140 would provide the search results based on the search condition (e.g., the GUI 350 identifying the same target object of the START button 354) to the AUT 121 without contacting the detection service 160.

According to embodiments of the present disclosure, testing tools provided with the AUT 121 send a current screenshot of a GUI and target object information to the cache 140. The cache 140 checks if search results based on the search conditions have already been cached. According to embodiments of the present disclosure, the cache 140 compares the screenshot or the target object information (e.g., if it's an image) of the search condition with cached search results. The comparison is determined from two aspects. First, the comparison is determined from a structural aspect. Structural comparison considers luminance, contrast, and structure. A typical method is Structural Similarity Index (SSI). A high SSI value shows that the two images are nearly identical or have very minor differences in luminance, contrast, and structure perspective.

To calculate the SSI of two images the following steps are performed: (1) convert the images into gray mode; (2) detect all the key points in the images; (3) match the key points; (4) calculate the similarities; and (5) resize the image with different scale factors. When converting the images into gray mole, the images are scaled to the same size.

The key points in the images are distinctive features in the images that can be robustly matched across different images. Examples of key points include corners, edges, blobs, etc. The following code is example code using Python and OpenCV library for image comparison:

sift = cv2.SIFT_create( )
kp1, des1 = sift.detectAndCompute(scaled_img1, None)
kp2, des2 = sift.detectAndCompute(scaled_img2, None)

Once the key points and their descriptors for both images have been found, the key points between them can be matched. A typical method of matching the key points is using a Flann-based matcher. The Flann-based matcher supports many algorithms to match the key points. The following are some algorithms that can be used for matching key points: KD-trees, KMeans-based indexing, linear search and composite index. An algorithm can be selected to handle different kinds of applications to determine the best algorithm to use with a specific application. Taking the KD-trees algorithm for example, this algorithm performs k-NN based matching for the descriptors of two images. The following is example code for matching the key points:

index_params = dict(algorithm=1, trees=5)
search_params = dict(checks=50)
flann = cv2.FlannBasedMatcher(index_params, search_params)
matches = flann.knnMatch(des1, des2, k=2)

In the above code, K is chosen with 2. This means for each key point in an image A, two similar points in image B are determined. Ideally, if two images are similar, for each key point in the image A, it is assumed there is only one best match in the image B. Other matched points should be far away. For example, for each key point in image A, several key points (e.g., candidate key points) are found in image B. Each candidate key point in image B will have a distance factor to describe the similarity with the corresponding key point in image A. The candidate key points are sorted according to their distances. If the two images are similar, the best matched key points should have a very small distance. This means that the two images are very similar to each other. Key points having a large distance means the two images are not similar to each other. Based on the above, distances between found matches can be compared. If distances are beyond a specific value, this key point is assumed a best match, otherwise it doesn't, and is ignored. The following is example code describing this feature:

good_matches = [ ]
for m, n in matches:
if m.distance < 0.7 * n.distance:
good_matches.append(m)

Note the weight 0.7 is pre-defined threshold value, it can be configured according to the practice.

After finding all of the matched key points, the similarities between the images can be calculated using the example code provided below:

tempSimilarity=len(good_matches)/max(len(des1),len(des2)).

To handle scale differences between images, the image with different scale factors can be resized. According to this approach, scale factors 0.5, 0.75 and 1.0 are used. After resizing, the above steps are repeated.

For each factor a similarity is obtained, and the average similarity is calculated using the example code provided below:

tempSimilarity = len(good_matches) / max(len(des1), len(des2))
total += tempSimilarity
count += 1
# Calculate the average value
similarity = total / count

According to embodiments of the present disclosure, pixel aspect comparison calculates the overall similarity in terms of color distribution, brightness, and contrast. A high value indicates the images look similar from a visual perspective. A typical method is comparing the histograms of two images. The histograms for two images are calculated and the distances are compared.

The Bhattacharyya distance metric is a good way to compare different probability distributions. It is commonly used in various fields, including statistics, machine learning, and image processing. The Bhattacharyya distance metric is used to compare the histograms of the screenshots. The following is example code employing the Bhattacharyya distance metric:

hist1 = cv2.calcHist([image1], [0, 1, 2], None, [256, 256, 256], [0, 256, 0, 256, 0, 256])
hist2 = cv2.calcHist([image2], [0, 1, 2], None, [256, 256, 256], [0, 256, 0, 256, 0, 256])
distance = cv2.compareHist(hist1, hist2, cv2.HISTCMP_BHATTACHARYYA)
probability = 1 / (1 + distance)

According to embodiments of the present disclosure, the Bhattacharyya distance metric comparison returns the distance of two histograms and the distance to two histograms is converted into a probability, having values between 0 and 1. A simple way for determining the probability is using the reciprocal of the distance plus one, to ensure that the probability ranges from 0 to 1, with higher values indicating higher similarity.

Both methods provide a similar probability. The two methods are combined, wherein the probability for each method is calculated. The average value from the two methods is used as the final probability. A threshold can be defined, for example 0.9. If the final probability exceeds the threshold, then it can be determined that two screenshots are similar, otherwise they are different.

The key to the algorithms and the processes described herein is that it would take an enormous amount of computer processing power to break. A person (e.g., using a pen and paper) could not realistically break the algorithms and the novel processes described herein.

According to embodiments of the present disclosure, the threshold also can be configured according to practice. If the search results based on the search condition are matched in the cache 140, the cache 140 returns the cached search results directly. If the search results based on the search condition are not matched in the cache 140, then the detection service 160 is contacted. According to embodiments of the present disclosure, if the search results based on the search condition are provided by the detection service 160, the detection service 160 updates the cache 140 with the search results based on the search condition. The detection service 160 further provides the search results based on the search condition to the AUT 121.

According to a further embodiment of the present disclosure, if the search results based on a first search condition from the detection service 160 only include one candidate search result, with a high degree of confidence, this means the target object provided in the first search condition is unique. Based on the search results of the first search condition from the detection service 160 only including one candidate search result with a high degree of confidence, when the AUT 121 sends a subsequent search condition, similar to the first search condition to the cache 140, the entire screenshot of the subsequent search condition is not required.

According to the further embodiment of the present disclosure, improvements can be made when updating the cache 140. For example, the entire screenshot is not saved. The search result includes an object area. FIG. 4 illustrates another example GUI 400 in accordance with embodiments of the present disclosure. As illustrated in FIG. 4, the GUI 400 provides the same dynamic content or animations as shown in GUIs 300 and 350 illustrated in FIG. 3. As illustrated in FIG. 4, GUI 400 depicts the canvas game entitled “Flappy Bird” 412, illustrating the bird 408, the ground elements 416 and the START button 404. A pre-defined distance around the target object (e.g., the START button 404) is extended, clipped from the screenshot and saved in the cache 140. As illustrated in FIG. 4, the extended area 420 around the target object 404 is clipped and saved in the cache 140.

When the search results are sent back to the testing tool of the AUT 121, a clipImage flag and a result area are added to the search results. The clipImage flag informs the testing tool of the AUT 121 that only one match was found in the search results. This means the target object, provided in the search condition, is unique in the application UI. The clipImage is linked to a specific step in the script and each step should have its own clipImage flag. The result area provides the location of the target object on the screenshot. According to an embodiment of the present disclosure, the location can be in the form of coordinates (e.g., x-y coordinates), the height of the target object, the weight of the target object, etc.

For a subsequent search condition at the same step of the test script or when the testing tool of the AUT 121 replays the same step of the test script, the clipImage flag is first checked. If the result of the clipImage flag is “TRUE,” then in the last iteration, only one match in the application UI was found indicating the target object was unique. Instead of sending the entire screenshot, the testing tool of the AUT 121 only sends the result area within a pre-defined distance (e.g., a clip out of the result area which represents the location of the target object). The pre-defined distance is illustrated in FIG. 4 as the extended area 420. The clip out of the result area is sent to the cache 140. The cache 140 uses the clip out of the result area to determine if the search results have been cached. If the cache 140 has determined that the search results have been cached based on the clip out of the result area, the cached search results are returned to the testing tool of the AUT 121. According to an embodiment of the present disclosure, if the cache 140 has not determined that the search results have been cached based on the clip out of the result area, this may mean that the screenshot has some differences from the last iteration (e.g., the target object may have moved, dynamic content provided in the screenshot, etc.) then a complete search condition is sent to the detection service 160. According to embodiments of the present disclosure, using the clip out of the result area (e.g., the extended image 420 of the START button 404 as illustrated in FIG. 4) as compared to using the entire screenshot, saves time.

By applying the above improvements, tests were performed, and the following data was obtained as indicated in the table below.

TABLE

| 1^{st} Time Without | With | With | With |
|---|---|---|---|
| Cache | Cache | Cache | Cache |
| 1st | 2nd | 3rd | 4th |
| 1666.36 ms | 84.60 ms | 81.62 ms | 84.67 ms |

As illustrated in the table, the first-time search required 1666.36 milliseconds (ms). The following search requests match the information stored in the cache 140 and only require 81 ms to 84 ms.

The computations used from the improvements provided above in performing the tests require computationally intensive tasks that could not practically be conducted as a metal process. Image recognition, matching, evaluation, etc., discussed above are of sufficient data size and complexity to not be understood by human mental work, let alone verified using the corresponding algorithms by human mental work. Such an immense number of potential matches (which may be in the thousands or millions) cannot be performed in the human mind, much less using pen and paper. Therefore, image recognition, matching and evaluation with the human mind are highly impractical.

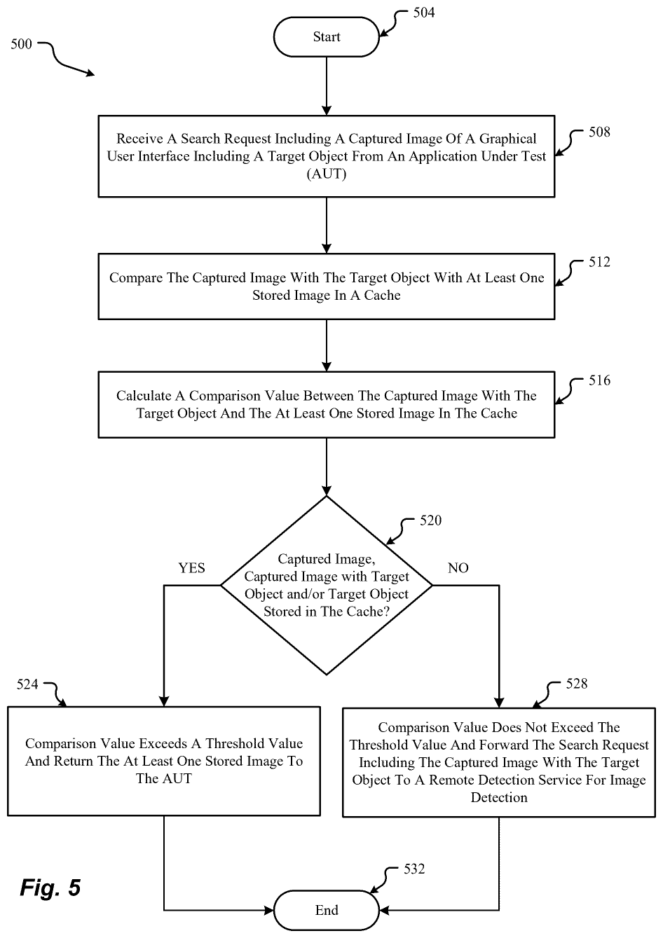

FIG. 5 depicts a flow diagram depicting a method 500 for analyzing AUTs to detect objects using image-based object identification in accordance with embodiments of the present disclosure. While a general order of the steps of method 500 is shown in FIG. 5, method 500 can include more or fewer steps or can arrange the order of the step differently than those shown in FIG. 5. Further, two or more steps may be combined in one step. Generally, method 500 starts at a START operation at step 504 and ends with an END operation at step 532. Method 500 can be executed as a set of computer-executable instructions executed by a computer system (e.g., the test communication device(s) 101, the test server device 120, the processor 204, etc.) and encoded or stored on a computer readable medium (e.g., memory 208, etc.). Hereinafter, method 500 shall be explained with reference to the systems, components, modules, applications, software, data structures, user interfaces, etc. described in conjunction with FIGS. 1-4.

As illustrated in FIG. 5, method 500 begins at the START operation at step 504 and proceeds to step 508, where the processor 204 of the test communication devices 101 or the test server device 120 receives a search request including a captured image of a GUI including a target object from an AUT.

After the processor 204 of the test communication devices 101 or the test server device 120 receives a search request including a captured image of a GUI including a target object from an AUT at step 508, method 500 proceeds to step 512, where the processor 204 of the test communication devices 101 or the test server device 120 compares the captured image with the target object with at least one stored image in a cache. After the processor 204 of the test communication devices 101 or the test server device 120 compares the captured image with the target object with at least one stored image in a cache at step 512, method 500 proceeds to step 516, where the processor 204 of the test communication devices 101 or the test/server device 120 calculates a comparison value between the captured image with the target object and the at least one stored image in the cache.

After the processor 204 of the test communication devices 101 or the test server device 120 calculates a comparison value between the captured image with the target object with the at least one stored image in the cache at step 516, method 600 proceeds to decision step 520 where the processor 204 of the test communication devices 101 or the test server device 120 determines if the captured image, the captured image with the target object or the target object is stored in the cache. If the captured image, the captured image with the target object and/or the target object is stored in the cache (YES) at decision step 520, method 500 proceeds to step 524 where the processor 204 of the test communication devices 101 or the test server device 120 determines that the comparison value exceeds a threshold value and returns the at least one stored image to the AUT.

If the captured image, the captured image with the target object and/or the target object is not stored in the cache (NO) at decision step 520, method 500 proceeds to step 528 where the processor 204 of the test communication devices 101 or the test server device 120 determines that the comparison value does not exceed the threshold value and forwards the search request including the captured image and the target object to a remote detection service for image detection.

After the processor 204 of the test communication devices 101 or the test server device 120 determines that the comparison value exceeds a threshold value and returns the at least one stored image to the AUT at step 524 or determines that the comparison value does not exceed the threshold value and forwards the search request including the captured image with the target object to a remote detection service for image detection, method 500 ends with the END operation at step 532.

Any of the steps, functions, and operations discussed herein can be performed continuously and automatically.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., a central processing unit (CPU), GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally, or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud,” multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a CPU with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of FPGA, ROM, PROM, EPROM, RAM, bus-accessible storage, network-accessible storage, etc.

These machine-executable instructions may be stored on one or more machine-readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as a Programmable Logic Device (PLD), a Programmable Logic Array (PLA), a FPGA, a Programmable Array Logic (PAL), special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or very-large-scale integration (VLSI) design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or Computer-Generated Imagery (CGI) script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

A neural network, as described herein may comprise layers of logical nodes having an input and an output. If an output is below a self-determined threshold level, the output may be omitted (i.e., the inputs may be within an inactive response portion of a scale and provide no output), if an output is above the threshold, the output may be provided (i.e., the inputs may be within the active response portion of the scale and provide the output). The particular placement of active and inactive delineation may be provided as a step or steps. Multiple inputs into a node may produce a multi-dimensional plane (e.g., hyperplane) to delineate a combination of inputs that are active or inactive.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

The claims presented herein are to be interpreted in light of the specification and drawings presented herein with sufficiently narrow scope such as to preclude any basic mental process that could be performed entirely in the human mind. The claims presented herein are to be interpreted in light of the specification and drawings presented herein with sufficiently narrow scope such as to preclude any process that could be performed entirely by human manual effort.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method, comprising:
receiving, by a processor, a search request including a captured image of a graphical user interface from an application under test;
comparing, by the processor, the captured image with at least one stored image in a cache;
calculating, by the processor, a comparison value between the captured image and the at least one stored image in a cache;
determining, by the processor, if the captured image has been stored in a cache by:
comparing, by the processor, the captured image with at least one stored image in the cache; and
calculating, by the processor, a comparison value between the captured image and the at least one stored image;
if the comparison value exceeds a threshold value, returning, by the processor, the at least one stored image to the application under test; and
if the comparison value does not exceed the threshold value, forwarding, by the processor, the search request including the captured image to a remote detection service for image detection.

2. The method according to claim 1, further comprising:
receiving, by the processor, search results from the remote detection service based on the forwarded search request,
wherein the search results include at least one candidate image;
updating, by the processor, the cache with the search request and the at least one candidate image; and
sending, by the processor, the at least one candidate image to the application under test.

3. The method according to claim 2, further comprising if the at least one candidate image includes one candidate image having a confidence score exceeding a predetermined value, updating, by the processor, the cache with the search request and a unique object extracted from the one candidate image instead of the one candidate image.

4. The method according to claim 2, further comprising if the at least one candidate image includes one candidate image having a confidence score exceeding a predetermined value, sending, by the processor, a unique object extracted from the one candidate image instead of the one candidate image to the application under test.

5. The method according to claim 4, further comprising determining, by the processor, if the unique object extracted from the one candidate image matches at least one stored object in the cache.

6. The method according to claim 1, wherein the comparison includes a structural comparison and a pixel comparison.

7. The method according to claim 6, wherein the structural comparison includes a structural similarity index method.

8. The method according to claim 6, wherein the pixel comparison includes comparing distances between histograms of images.

9. The method according to claim 6, wherein probabilities from the structural comparison and the pixel comparison are combined to determine the threshold value.

10. A system, comprising:
a processor; and
a memory coupled with and readable by the processor and storing therein a set of instructions which, when executed by the processor, causes the processor to:
receive a search request including a captured image of a graphical user interface from an application under test;
determine if the captured image has been stored in a cache by:
compare the captured image with at least one stored image in the cache; and
calculate a comparison value between the captured image and the at least one stored image;
if the comparison value exceeds a threshold value, return the at least one stored image to the application; and
if the comparison value does not exceed the threshold value, forward the search request including the captured image to a remote detection service for image detection.

11. The system according to claim 10, wherein the instructions further cause the processor to:
receive search results from the remote detection service based on the forwarded search request,
wherein the search results include at least one candidate image;
update the cache with the search request and the at least one candidate image; and
send the at least one candidate image to the application under test.

12. The system according to claim 11, wherein the instructions further cause the processor to if the at least one candidate image includes one candidate image having a confidence score exceeding a predetermined value, update the cache with the search request and a unique object extracted from the one candidate image instead of the one candidate image.

13. The system according to claim 11, wherein the instructions further cause the processor to if the at least one candidate image includes one candidate image having a confidence score exceeding a predetermined value, send a unique object extracted from the one candidate image instead of the one candidate image to the application under test.

14. The method according to claim 13, wherein the instructions further cause the processor to determine if the unique object extracted from the one candidate image, matches at least one stored object in the cache.

15. The system according to claim 10, wherein the comparison includes a structural comparison and a pixel comparison.

16. The system according to claim 15, wherein the structural comparison includes a structural similarity index method.

17. The system according to claim 15, wherein the pixel comparison includes comparing distances between histograms of images.

18. The system according to claim 15, wherein probabilities from the structural comparison and the pixel comparison are combined to determine the threshold value.

19. A non-transitory computer readable medium having stored thereon instructions that cause a processor to execute a method, the method comprising instructions to:
receive a search request including a captured image of a graphical user interface from an application under test;
determine if the captured image has been stored in a cache by:
comparing the captured image with at least one stored image in the cache; and
calculating a comparison value between the captured image and the at least one stored image;
if the comparison value exceeds a threshold value, return the at least one stored image to the application under test; and
if the comparison value does not exceed the threshold value, forward the search request including the captured image to a remote detection service for image detection.

20. The non-transitory computer readable medium according to claim 19, wherein the instructions further cause the processor to:
receive search results from the remote detection service based on the forwarded search request,
wherein the search results include at least one candidate image;
update the cache with the search request and the at least one candidate image; and
send the at least one candidate image to the application under test.
